(19) United States
(12) Patent Application Publication
(10) Pub. No.: US 2007/0017982 A1
(43) Pub. Date: Jan. 25, 2007

(54) Cash drawer tender separator

(76) Inventor: Robert S. Hoblit, Knightdale, NC (US)

Correspondence Address: MARCIA L. DOUBET LAW FIRM, P.O. BOX 422859, KISSIMMEE, FL, 34742-2589, US

(21) Appl. No.: 11/185,495

(22) Filed: Jul. 20, 2005

(51) Int. Cl. G06K 15/00; G07G 1/00; G06K 7/00

(52) U.S. Cl. 235/383; 235/486; 235/7 R

(57) ABSTRACT

A tender separator for placement in a section of a till, such that tenders can be separated within the section by placing a first form of tender below the separator and a second form of tender above the separator. Preferably, the tender separator is movable in a vertical direction to accommodate varying amounts of the first form of tender. Optionally, the tender separator may be adapted for placement in one or more tracks of a back of the section, such that the tender separator is movable, in a vertical direction, in the one or more tracks. As another option, more than one separator may be placed in one section of the till, such that multiple forms of tender can be separated within the section by placing the tender separators between the multiple forms of tender. The tender separators may be tabbed and/or flexible (e.g., for easier access to tenders placed therebeneath).

### BACKGROUND OF THE INVENTION

The present invention relates generally to drawers for storing tender (e.g., cash and other payment instruments such as checks) in cash registers and point-of-sale devices, and more particularly, to separators that enable separating non-coin forms of tender within sections of such drawers.

In the United States and in many other countries where non-coin forms of tender are placed in a “face-up” or horizontal position, the tender drawers (often referred to equivalently as “cash drawers”) have a fixed number of sections or slots for currency and other tenders. Tender drawers for use with United States currency, for example, typically have 5 rectangular sections for storing paper-type tender and 4 generally square sections for storing coins. This arrangement fits a specific footprint for the drawer. See FIG. 1, where a typical prior art cash drawer 100 is illustrated (from a top view). Reference number 110 indicates a rectangular section for non-coin tender, and reference number 120 indicates a coin section.

However, because more than 5 unique forms of non-coin tender are accepted, common procedure is to either stack multiple forms of tender within a single section or, alternatively, to use a media sub-drawer within the cash drawer. As an example of the first approach, a retailer that accepts gift certificates and government-issued food stamp coupons might, by convention, place these forms of tender in the same section as, but underneath, $20 bills. As further examples of the first approach, customer checks might also be placed in a section shared by paper currency, and food stamp coupons with a face value of $1 might be placed in the same section as $1 bills. As an example of the second approach, a retailer might conventionally store checks and large bills in a separate “sub-drawer” section of the cash drawer, where this separate section is located underneath the till (i.e., underneath the cash drawer). This separate section is typically accessible by inserting tender into a slot (where this slot may be accessible without opening the cash drawer itself), but items placed into the slot are then generally inaccessible until the cash drawer is removed (e.g., when a change of cashier or similar operator, referred to herein as a cashier by way of illustration, occurs).

When a cash drawer is open, a potential exists for items to be stolen therefrom. Mixing forms of tender within sections of a cash drawer tends to create an unorganized drawer, requiring the drawer to be open longer—and therefore increasing the potential for theft—as the cashier inspects, retrieves, organizes, and/or sorts tenders in the various sections. While media sub-drawers work well for limiting the amount of tender mixing within the sections of the cash drawer, some cashiers do not use the media slot, preferring instead to lift the front of the cash drawer in order to expose the sub-drawer for easy access. This also creates a potential for theft. Furthermore, some cash drawer manufacturers do not provide a media slot, therefore forcing the cashiers to Lift the cash drawer when placing tender into the underlying sub-drawer.

### BRIEF SUMMARY OF THE INVENTION

In one aspect, the present invention provides a tender separator for placement in a section of a till, such that tenders can be separated within the section by placing a first form of tender below the separator and a second form of tender above the separator. Preferably, the tender separator is movable in a vertical direction to accommodate varying amounts of the first form of tender. Optionally, the tender separator may be adapted for placement in one or more tracks of a back of the section, such that the tender separator is movable, in a vertical direction, in the one or more tracks. As another option, more than one tender separator may be placed in a section of the till, such that tenders can be further separated within the section by placing (for example) the second tender separator above the second form of tender and placing a third form of tender above the second separator.

In another aspect, the present invention provides a method of separating tenders in a till, comprising steps of: placing a tender separator in a section of a till; placing a first form of tender below the separator; and placing a second form of tender above the separator. The tender separator may be formed of a flexible material, such that an operator can bend the tender separator to access the first form of tender. In addition or instead, the tender separator may be tabbed on a front side thereof, such that an operator can lift the tab of the tender separator to access the first form of tender.

In a further aspect, the present invention provides a till comprising a plurality of sections for placement of tenders and at least one tender separator placed in at least one of the sections, such that multiple forms of tender can be separated within each of the at least one sections by placing each of the at least one tender separators between different ones of the multiple forms of tender. Preferably, each of the at least one tender separators are placed in a horizontal orientation and are movable in a vertical direction to accommodate varying amounts of a form of tender placed therebeneath. The till may further comprise one or more tracks in a back side of at least one of the sections, the one or more tracks adapted for holding the at least one tender separator placed in the section, such that the at least one tender separator is movable, in a vertical direction, in the one or more tracks.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a typical cash drawer of the prior art (from a top view);

FIG. 2 illustrates a section of a cash drawer, showing placement of a tender separator therein, according to one or more embodiments of the present invention;

FIG. 3 illustrates use of multiple tender separators within a single section of a cash drawer, where tabs on the tender separators are placed at varying positions, according to one or more embodiments of the present invention; and

FIGS. 4 and 5 show placement of a tender separator in a cash drawer according to an optional feature of the present invention, whereby the tender separator rises up and down using one or more tracks placed at the back of the cash drawer section.

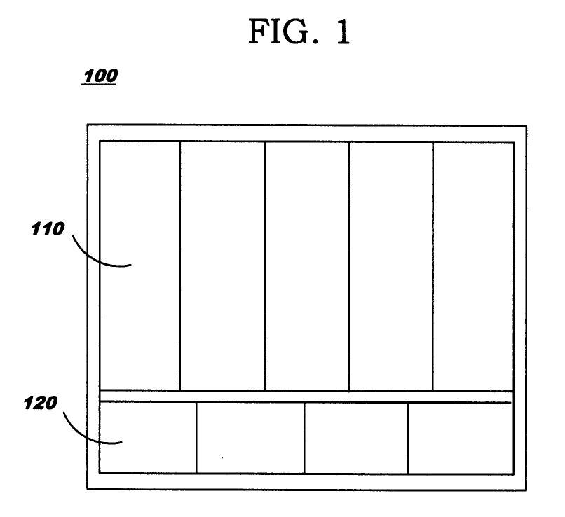

### DETAILED DESCRIPTION OF THE INVENTION

Embodiments of the present invention are directed toward enabling multiple tenders to be mixed within a section of the cash drawer without being unorganized. Using teachings disclosed herein, cash drawers may be kept neater and accessed more easily and efficiently by cashiers, and exposure to theft may be reduced.

According to preferred embodiments, a tender separator is placed in a horizontal orientation within one or more of the sections of a cash drawer. Optionally, more than one such tender separator may be placed within any one section. The tender separator is preferably made of a durable, semi-flexible material such as plastic. For example, a plastic similar to that used for plastic milk jugs may be used. Use of a flexible material enables the cashier to bend the tender separator backwards, if desired, in order to easily access the tender stacked underneath.

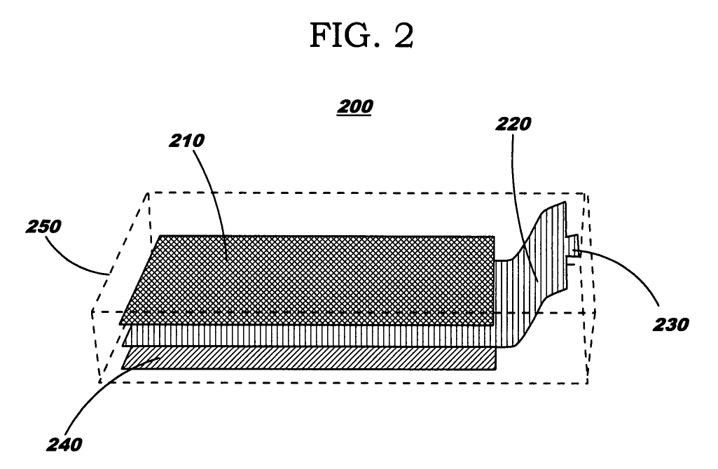

Referring now to FIG. 2, a section 200 of a cash drawer is illustrated, showing placement of a tender separator 220 therein, according to one or more embodiments of the present invention. A first form of tender (see, generally, reference number 240) can then be placed below the separator, while a second form of tender (see, generally, reference number 210) is placed above the separator. In preferred embodiments, the tender separator has a smooth upward curve at the front, or “cashier side”, of the till. Preferably, the degree of the curve is minimal, such that the topmost tenders do not become unruly in the till.

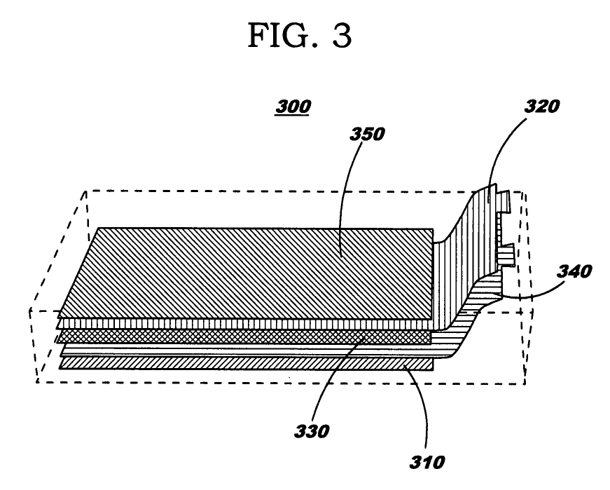

Preferred embodiments of the tender separator have a tab 230 at the front edge. A tab allows for easy lifting of the separator, such that the various forms of tender stacked in the section can be easily accessed while remaining physically separated. Tabs may be placed in a uniform position on all tender separators, such as in the middle of the front edge. Alternatively, tabs may be placed at varying positions, such as the tabs on file folders (commonly referred to as “⅓ cut” or ⅕ cut”, indicating tabs that occupy a varying ⅓ or ⅕, respectively, of an edge). Use of tabs placed at varying positions facilitates use of multiple separators within one section of a cash drawer. This is illustrated in FIG. 3, where section 300 of a cash drawer has two tender separators 320, 340, with these two separators used to separate three forms of tender 310, 330, 350. For example, by placing two tender separators in a single section, the section can be used for stacking bills in denominations of $20, $50, and $100; or, $20 bills, checks, and gift certificates might be stacked in a single section having two tender separators.

Tenders separators of the type described with reference to FIGS. 2 and 3 may be placed in a conventional cash drawer, with no retrofitting required and no changes required to the footprint of the cash drawer. Due to the flexible nature of the material used in preferred embodiments, the cashier may easily lift up or bend the front portion of the separator (e.g., using its tab), and insert or remove tenders from that location. Because the cashier does not have to search for the different tenders within the cash drawer section, in contrast to use of prior art cash drawers without tender separators, the stacked tenders can be accessed more quickly when using one or more tender separators in the section. The cashier may therefore reduce the length of time the cash drawer is open, and exposure to theft may be reduced.

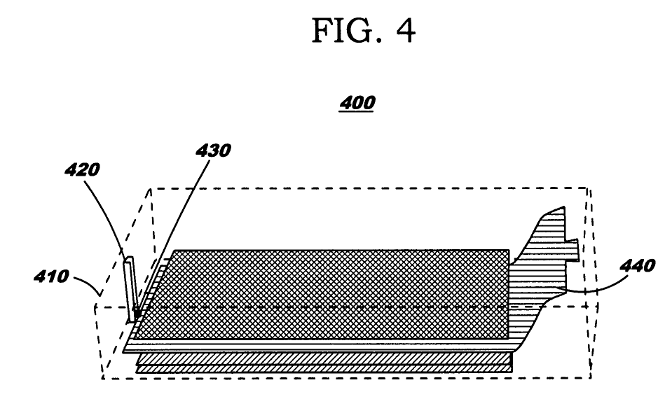

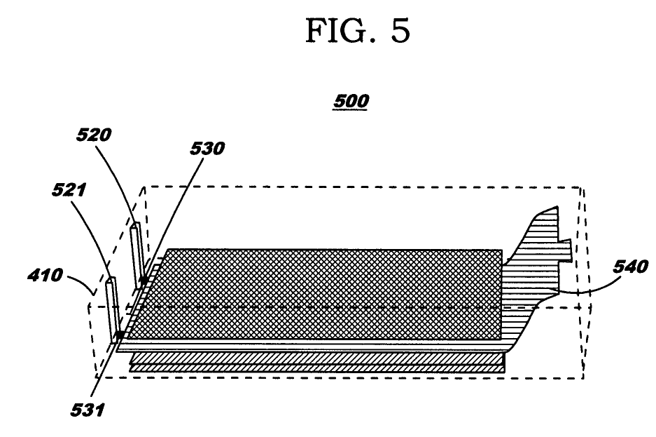

Tender separators according to preferred embodiments are placed in a cash drawer section such that the separator can raise and lower, depending on how many bills or other tenders are placed beneath the separator at a point in time. Accordingly, the separators of one or more embodiments are free-floating within the cash drawer section. See, for example, tender separator 220 of FIG. 2, which has its back side placed along the back 250 of section 200 of the cash drawer. As an alternative, the back of the section may be adapted with one or more tracks. Use of such tracks is an optional feature of the present invention, and is illustrated in FIGS. 4 and 5. As shown in FIG. 4, a track 420 is provided in the back 410 of a cash drawer section 400, such that a corresponding tab 430 on the back of the tender separator 440 can be placed in the track. The tender separator 440 may therefore rise up and down, vertically, within the track(s) as the amount of tender stacked beneath it varies. In FIG. 5, an embodiment is shown using two tracks (although more than two tracks might be used, if desired). As shown therein, the back of the tender separator 540 has two tabs 530, 531, and these tabs are placed in corresponding tracks 520, 521 of the cash drawer section. As yet another alternative, one or more tracks may be disposed along the rear of the sides of the cash drawer section, rather than on the back of the section.

Optionally, tender separators may be color-coded. In addition or instead, the tabs on tender separators may be color-coded. Such color-coding may serve as a visual distinction or indicator of (for example) which type of tender is placed beneath the separator or the separator's current position (i.e., vertical height) in the cash drawer section. Use of color-coding may increase the cashier's speed and efficiency of accessing the stacked tenders.

Cash drawers of the prior art may have a hinged, spring-loaded arm adapted for resting on the top of tenders stacked in a cash drawer section, thereby holding the stack of tenders in place. Tender separators as disclosed herein may be used in such cash drawers, separating forms of tender held beneath the spring-loaded arm. Typically, such spring-loaded arms extend only part of the length of the cash drawer sections, and the arm may therefore serve as a point of resistance against which the tender separator can be bent.

As will be appreciated by one of skill in the art, embodiments of the present invention may be provided as methods for separating tenders in a till, tender separators, and/or tills or cash drawers with one or more tender separators placed therein.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

1. A tender separator for placement in a section of a till, such that tenders can be separated within the section by placing a first form of tender below the separator and a second form of tender above the separator.

2. The tender separator according to claim 1, wherein the tender separator is formed of a flexible material.

3. The tender separator according to claim 1, wherein the tender separator is tabbed on a front side thereof.

4. The tender separator according to claim 1, wherein the tender separator is movable in a vertical direction to accommodate varying amounts of the first form of tender.

5. The tender separator according to claim 1, wherein the tender separator is adapted for placement in one or more tracks of a back of the section, such that the tender separator is movable, in a vertical direction, in the one or more tracks.

6. The tender separator according to claim 1, wherein the tender separator is color-coded.

7. The tender separator according to claim 6, wherein the color-coding serves as a visual indicator of the first form of tender placed therebelow.

8. The tender separator according to claim 6, wherein the color-coding serves as a visual indicator of a current vertical position of the tender separator in the section.

9. The tender separator according to claim 1, further comprising a color-coded tab located on a front side thereof.

10. The tender separator according to claim 1, wherein a second tender separator can be placed in the section of the till, such that tenders can be further separated within the section by placing the second tender separator above the second form of tender and placing a third form of tender above the second separator.

11. A method of separating tenders in a till, comprising steps of:
placing a tender separator in a section of a till;
placing a first form of tender below the separator; and
placing a second form of tender above the separator.

12. The method according to claim 11, wherein the tender separator is formed of a flexible material, such that an operator can bend the tender separator to access the first form of tender.

13. The method according to claim 11, wherein the tender separator is tabbed on a front side thereof, such that an operator can lift the tab of the tender separator to access the first form of tender.

14. The method according to claim 11, wherein the tender separator is movable in a vertical direction to accommodate varying amounts of the first form of tender.

15. The method according to claim 11, wherein the tender separator is adapted for placement in one or more tracks of a back of the section, such that the tender separator is movable, in a vertical direction, in the one or more tracks.

16. The method according to claim 11, further comprising the steps of:
placing a second tender separator in the section of the till, above the second form of tender; and
placing a third form of tender above the second separator.

17. A till, comprising:
a plurality of sections for placement of tenders;
at least one tender separator placed in at least one of the sections, such that multiple forms of tender can be separated within each of the at least one sections by placing each of the at least one tender separators between different ones of the multiple forms of tender.

18. The till according to claim 17, wherein at least one of the tender separators is formed of a flexible material.

19. The till according to claim 17, wherein at least one of the tender separators is tabbed on a front side thereof.

20. The till according to claim 17, wherein each of the at least one tender separators are placed in a horizontal orientation and are movable in a vertical direction to accommodate varying amounts of a form of tender placed therebeneath.

21. The till according to claim 17, wherein at least one of the sections further comprises one or more tracks in a back side thereof, the one or more tracks adapted for holding the at least one tender separator placed in the section, such that the at least one tender separator is movable, in a vertical direction, in the one or more tracks.

22. The till according to claim 17, wherein a plurality of tender separators are provided and wherein color-coding is used as a visual distinction on at least two of the tender separators.

23. The till according to claim 17, wherein a plurality of tender separators are provided and wherein a color-coded tab is located on a front side of at least two of the tender separators.

24. A till, comprising:
a plurality of sections for placement of tenders;
a first number, “N”, of tender separators placed in one or more of the sections, such that a second number, “N+1”, form of tender can be separated within the one or more sections, each of the “N” tender separators placed between different ones of the “N” forms of tender.
